(19) United States
(12) Patent Application Publication
(10) Pub. No.: US 2007/0081589 A1
(43) Pub. Date: Apr. 12, 2007

(54) Adaptive quantization controller and methods thereof

(75) Inventors: Jong-sun Kim, Yongin-si (KR); Jae-young Beom, Hwaseong-si (KR); Kyoung-mook Lim, Hwaseong-si (KR); Jea-hong Park, Seongnam-si (KR); Seung-hong Jeon, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/505,313

(22) Filed: Aug. 17, 2006

(30) Foreign Application Priority Data
Oct. 12, 2005 (KR) 10-2005-0096168

(51) Int. Cl. H04N 11/04; H04N 7/12; H04B 1/66

(52) U.S. Cl. 375/240.03; 375/240.12; 375/240.24; 375/240.27

(57) ABSTRACT

An adaptive quantization controller and methods thereof are provided. In an example method, motion prediction may be performed on at least one frame included in an input frame based on a reference frame. A prediction error may be generated as a difference value between the input frame and the reference frame. An activity value may be computed based on a received macroblock, the received macroblock associated with one of the input frame and the prediction error. A quantization parameter may be generated by multiplying a reference quantization parameter by a normalization value of the computed activity value. In another example method, an input frame including an I frame may be received and motion prediction for the I frame may be performed based at least in part on information extracted from one or more previous input frames. In a further example, the adaptive quantization controller may perform the above-described example methods.

### PRIORITY STATEMENT

This application claims the benefit of Korean Patent Application No. 10-2005-0096168, filed on Oct. 12, 2005, in the Korean Intellectual Property Office, the disclosure of which is incorporated herein in its entirety by reference.

### BACKGROUND OF THE INVENTION

1. Field of the Invention

Example embodiments of the present invention relate generally to an adaptive quantization controller and methods thereof, and more particularly to an adaptive quantization controller for performing motion prediction and methods thereof.

2. Description of the Related Art

In moving picture experts group (MPEG)-2, MPEG-4, and H.264 standards, an input image or frame may be divided into a plurality of luminance blocks and “macroblocks”. Each of the plurality of macroblocks and luminance blocks may have the same number of pixels (e.g., 8×8 pixels for luminance blocks, 16×16 pixels for macroblocks, etc.). Motion prediction, including motion estimation and motion compensation, may be performed in units of luminance blocks. Discrete cosine transform (DCT) and quantization may be performed in units of blocks, each having the same number of pixels (e.g., 8×8 pixels), variable-length code the input image or frame in order to facilitate the video encoding process.

Conventional moving picture encoders using the MPEG-2, MPEG4, and/or H.264 standards may perform a decoding process on an input image or frame to generate a decoded macroblock. The decoded macroblock may be stored in memory and used for encoding a subsequent frame.

In order to facilitate streaming video within bandwidth limited systems, a given amount of video data, determined by the encoding format (e.g., MPEG-2, MPEG-4, H.264, etc.) may be transferred through a limited transmission channel. For example, a MPEG-2 moving picture encoder may employ an adaptive quantization control process in which a quantization parameter or a quantization level may be supplied to a quantizer of the moving picture encoder. The supplied quantization parameter/level may be controlled based on a state of an output buffer of the moving picture encoder. Because the quantization parameter may be calculated based on the characteristics of a video (e.g., activity related to temporal or spatial correlation within frames of the video), a bit usage of the output buffer may be reduced.

Conventional MPEG-2 moving picture encoders may support three encoding modes for an input frame. The three encoding modes may include an Intra-coded (I) frame, a Predictive-coded (P) frame, and a Bidirectionally predictive-coded (B) frame. The I frame may be encoded based on information in a current input frame, the P frame may be encoded based on motion prediction of a temporally preceding I frame or P frame, and the B frame may be encoded based on motion prediction of a preceding I frame or P frame or a subsequent (e.g., next) I frame or P frame.

Motion estimation may typically be performed on a P frame or B frame and motion-compensated data may be encoded using a motion vector. However, an I frame may not be motion-estimated and the data within the I frame may be encoded. Thus, in a conventional adaptive quantization control method, activity computation for the P frame and the B frame may be performed based on a prediction error that may be a difference value between a current input frame and the motion-compensated data, or alternatively, on a DCT coefficient for the prediction error. The activity computation for the I frame may be performed on the data of the I frame.

Accordingly, activity computation for a neighboring P frame or B frame either preceding or following an I frame may be performed based on one or more of temporal and spatial correlation using motion estimation, but activity computation for the I frame may be based only on spatial correlation, and not a temporal correlation. Thus, adaptive quantization control in the I frame may have lower adaptive quantization efficiency than in a neighboring frame (e.g., an adjacent frame, such as a previous frame or next frame) of the I frame and temporal continuity between quantization coefficients for blocks included in the I frame may be broken, thereby resulting in degradation in visual quality. Because human eyes may be more sensitive to a static region (e.g., a portion of video having little motion), the above-described video quality degradation may become more pronounced problem if a series of input frames include less motion (e.g., as a bit rate decreases). Further, because a neighboring frame of the I frame may use the I frame as a reference frame for motion estimation, the visual quality of the I frame may also be degraded, such that video quality degradation may be correlated with a frequency of the I frames.

### SUMMARY OF THE INVENTION

An example embodiment of the present invention is directed to an adaptive quantization controller, including a prediction error generation unit performing motion prediction on at least one frame included within an input frame based on a reference frame and generating a prediction error, the prediction error being a difference value between the input frame and the reference frame, an activity computation unit outputting an activity value based on a received macroblock, the received macroblock associated with one of the input frame and the prediction error and a quantization parameter generation unit generating a quantization parameter by multiplying a reference quantization parameter by a normalization value of the outputted activity value.

Another example embodiment of the present invention is directed to a method of adaptive quantization control, including performing motion prediction on at least one frame included in an input frame based on a reference frame, generating a prediction error, the prediction error being a difference value between the input frame and the reference frame, computing an activity value based on a received macroblock, the received macroblock associated with one of the input frame and the prediction error and generating a quantization parameter by multiplying a reference quantization parameter by a normalization value of the computed activity value.

Another example embodiment of the present invention is directed to a method of adaptive quantization control, including receiving an input frame including an I frame and performing motion prediction for the I frame based at least in part on information extracted from one or more previous input frames.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

FIG. 1 is a block diagram of an adaptive quantization controller for a moving picture encoder according to an example embodiment of the present invention.

FIG. 2 illustrates an activity computation unit according to another example embodiment of the present invention.

FIG. 3 is a block diagram illustrating another adaptive quantization controller of a moving picture encoder according to another example embodiment of the present invention.

FIG. 4 is a flowchart illustrating an adaptive quantization control process for a moving picture encoder according to another example embodiment of the present invention.

FIG. 5 illustrates a flow chart of an activity value computation according to another example embodiment of the present invention.

FIG. 6 is a graph illustrating a conventional peak signal-to-noise ratio (PSNR) curve and a PSNR curve according to an example embodiment of the present invention.

FIG. 7 is a graph illustrating another conventional PSNR curve and another PSNR curve according to an example embodiment of the present invention.

FIG. 8 illustrates a table showing set of simulation results of a conventional adaptive quantization control process and a set of simulation results for an adaptive quantization control process according to an example embodiment of the present invention.

FIG. 9 illustrates a table showing a set of simulation results of motion prediction using an I frame motion prediction and a set of simulation results of motion prediction without using I frame motion prediction according to example embodiments of the present invention.

FIG. 10 illustrates a table showing a set of simulation results for motion prediction wherein a reference frame of an I frame is an original frame and a set of simulation results wherein the reference frame of the I frame is a motion-compensated frame according to example embodiments of the present invention.

### DETAILED DESCRIPTION OF EXAMPLE EMBODIMENTS OF THE PRESENT INVENTION

Detailed illustrative example embodiments of the present invention are disclosed herein. However, specific structural and functional details disclosed herein are merely representative for purposes of describing example embodiments of the present invention. Example embodiments of the present invention may, however, be embodied in many alternate forms and should not be construed as limited to the embodiments set forth herein.

Accordingly, while example embodiments of the invention are susceptible to various modifications and alternative forms, specific embodiments thereof are shown by way of example in the drawings and will herein be described in detail. It should be understood, however, that there is no intent to limit example embodiments of the invention to the particular forms disclosed, but conversely, example embodiments of the invention are to cover all modifications, equivalents, and alternatives falling within the spirit and scope of the invention. Like numbers may refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. Conversely, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

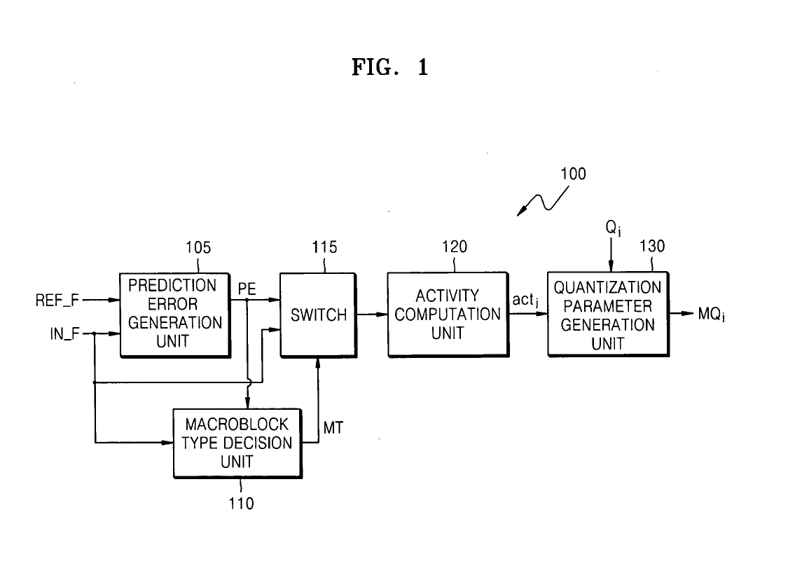

FIG. 1 is a block diagram of an adaptive quantization controller 100 for a moving picture encoder according to an example embodiment of the present invention. Referring to FIG. 1, the adaptive quantization controller 100 may include a prediction error generation unit 105, a macroblock type decision unit 110, a switch 115, an activity computation unit 120, and a quantization parameter generation unit 130.

In the example embodiment of FIG. 1, the prediction error generation unit 105 may perform motion prediction (e.g., motion estimation and motion compensation) on an input frame IN_F based on a reference frame REF_F. The prediction error generation unit 105 may generate a prediction error PE. The prediction error PE may represent a difference between the input frame IN_F and a motion-compensated frame (e.g., the reference frame REF_F).

In the example embodiment of FIG. 1, the input frame IN_F may be a current “original” frame (e.g., a non-motion compensated frame). The input frame IN_F may include an I frame, a P frame, and a B frame based on an encoding mode of the moving picture encoder. The reference frame REF_F may be stored in a frame memory of the moving picture encoder.

In the example embodiment of FIG. 1, because the I frame may represent coded data, a reference frame for the I frame be an original frame (e.g., a non-motion compensated frame) of a preceding (e.g., previous) P frame or I frame. Alternatively, the reference frame may be a motion-compensated frame (e.g., alternatively referred to as a “reconstructed” frame) of the preceding (e.g., previous) P frame or I frame. A reference frame for the P frame may be a motion-compensated frame of a preceding (e.g., previous) P frame or I frame, and a reference frame for the B frame may be a motion-compensated frame of a preceding P frame or I frame and/or a subsequent (e.g., next) P frame or I frame.

In the example embodiment of FIG. 1, the prediction error generation unit 105 may include a motion estimation processor (not shown), a motion compensation processor (not shown), and a subtractor (not shown). The motion estimation processor may perform motion estimation based on the input frame IN_F and the reference frame REF_F stored in the frame memory and may output a motion vector. In an example, a reference block used in motion estimation of the I frame, the P frame, and the B frame be a macroblock of a given pixel grid size (e.g., 16×16, 4×4, 4×8, 8×4, 8×8, 8×16, 16×8, etc.). The motion compensation processor may read a motion-compensated frame from the reference frame stored in the frame memory based on the motion vector. The subtractor may subtract the motion-compensated frame REF_F from the input frame IN_F and may generate the prediction error PE.

In the example embodiment of FIG. 1, the macroblock type decision unit 110 may output macroblock type information MT indicating whether a macroblock type is an inter macroblock (e.g., or non-intra macroblock) or an intra macroblock in response to the input frame IN_F and the prediction error PE.

In the example embodiment of FIG. 1, the switch 115 may output one of the prediction error PE and the input frame IN_F to the activity computation unit 120 in response to the macroblock type information MT. For example, the switch 115 may output the prediction error PE if the macroblock type information MT indicates the inter macroblock type and the switch 115 may output the input frame IN_F in units of macroblocks if the macroblock type information MT indicates the intra macroblock type. In another example, the prediction error PE and the input frame IN_F may be output as a frame.

In the example embodiment of FIG. 1, the activity computation unit 120 may receive a macroblock (e.g., an inter macroblock of the prediction error PE, an intra macroblock of the input frame IN_F) from the switch 115, may perform activity computation, and may output a temporal and spatial activity value actⱼ of a macroblock j.

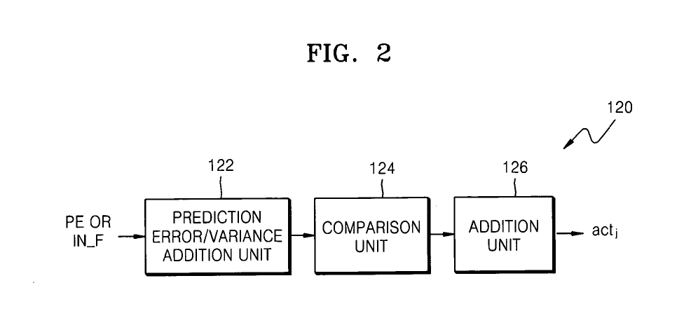

FIG. 2 illustrates the activity computation unit 120 of FIG. 1 according to another example embodiment of the present invention. In the example embodiment of FIG. 2, the activity computation unit 120 may include a prediction error/variance addition unit 122, a comparison unit 124, and an addition unit 126.

In the example embodiment of FIG. 2, if the switch 115 outputs the inter macroblock of the prediction error PE, the prediction error/variance addition unit 122 may perform an operation on an inter macroblock of the prediction error PE wherein absolute values of prediction error values Eₖⁿ, included within the inter macroblock of the prediction error PE, may be added together. The result of the addition may be output as a luminance sub-block value (e.g., with an 8×8 pixel size) sblkₙ, as shown by

$${sblk}_{n} = {\sum }_{k = 1}^{64} \vert {E}_{k}^{n} \vert \qquad Equation 1$$

wherein Eₖⁿ may indicate a prediction error value in an n^{th} 8×8 prediction video block, and n may be a positive integer (e.g., 1, 2, 3, 4, etc.). In Equation 1, it is assumed that the luminance sub-block value sblkₙ may correspond to an 8×8 pixel grid (e.g., because 64 may be representative of 8 multiplied by 8). However, it is understood that other example embodiments may be directed to other pixel grid sizes, and the values illustrated in Equation 1 may scale accordingly.

In the example embodiment of FIG. 2, if the switch 115 outputs the intra macroblock of the input frame IN_F, the prediction error/variance addition unit 122 may perform an operation on the intra macroblock of the input frame IN_F wherein absolute values of variance values obtained by subtracting a mean sample value P_meanₙ from sample values (e.g., pixel values) Pₖⁿ included within the intra macroblock of the input frame IN_F may be added together. The result of the addition may be output as a luminance sub-block value (e.g., with an 8×8 pixel size) sblkₙ, as shown by

$$\begin{matrix}{sblk}_{n} = {\sum }_{k = 1}^{64} \vert {P}_{k}^{n} - {P\_mean}_{n} \vert \\ wherein & Equation 2 \\ {P\_mean}_{n} = \frac{1}{64} \times {\sum }_{k = 1}^{64} {P}_{k}^{n} & Equation 3\end{matrix}$$

wherein Pₖⁿ may indicate a sample value in an n^{th} 8×8 original video block, P_meanₙ may indicate a mean value of n^{th} sample values, and n may be a positive integer (e.g., 1, 2, 3, 4, etc.). In Equation 2, it is assumed that the luminance sub-block value sblkₙ may correspond to an 8×8 pixel grid (e.g., because 64 may be representative of 8 multiplied by 8). However, it is understood that other example embodiments may be directed to other pixel grid sizes, and the values illustrated in Equation 2 may scale accordingly.

In the example embodiment of FIG. 2, the comparison unit 124 may compare sub-block values sblk₁, sblk₂, sblk₃, and sblk₄ and may output the sub-block value with the lowest value. The addition unit 126 may increment (e.g., by 1) the lowest value of the compared sub-block values and may output an activity value actⱼ. Accordingly, the above-described operation performed by the comparison unit 124 and the addition unit 126 may be expressed by
act_{j =}1+min(sblk₁, sblk₂, sblk₃, and sbik4) Equation 4

Returning to the example embodiment of FIG. 1, the quantization parameter generation unit 130 may multiply a reference quantization parameter Qⱼ by a normalization value N_actⱼ of the activity value actⱼ , thereby generating an adaptive quantization value or quantization parameter MQⱼ. The reference quantization parameter Qⱼ may be determined based on a level to which an output buffer of the moving picture encoder is filled (e.g., empty, filled to capacity, 40% full, etc.). For example, the reference quantization parameter Qⱼ may increase if the number of bits generated from the output buffer is greater than a threshold value, and the reference quantization parameter Qⱼ may decrease if the number of bits generated from the output buffer is not greater than the threshold value. The quantization parameter MQⱼ may be an optimal quantization parameter for the I frame, the P frame, and the B frame and may be provided to a quantizer of the moving picture encoder. Thus, the bit usage of the output buffer (e.g., the bit usage with respect to the I frame) may be reduced. The quantizer may quantize a DCT coefficient output from a discrete cosine transformer of the moving picture encoder in response to the quantization parameter MQⱼ, and may output a quantization coefficient.

In the example embodiment of FIG. 1, the quantization parameter generation unit 130 may output the quantization parameter MQⱼ as

$${N\_act}_{j} = \frac{2 * {act}_{j} + {mean\_act}_{j}}{{act}_{j} + 2 * {mean\_act}_{j}} \qquad Equation 5$$

wherein N_actⱼ may denote a normalized activity and mean_actⱼ may denote a mean value of activities. Then, the parameter N_actⱼ may multiplied by Qⱼ to attain MQⱼ , which may be expressed as
MQⱼ=Qⱼ* N_actⱼ Equation 6

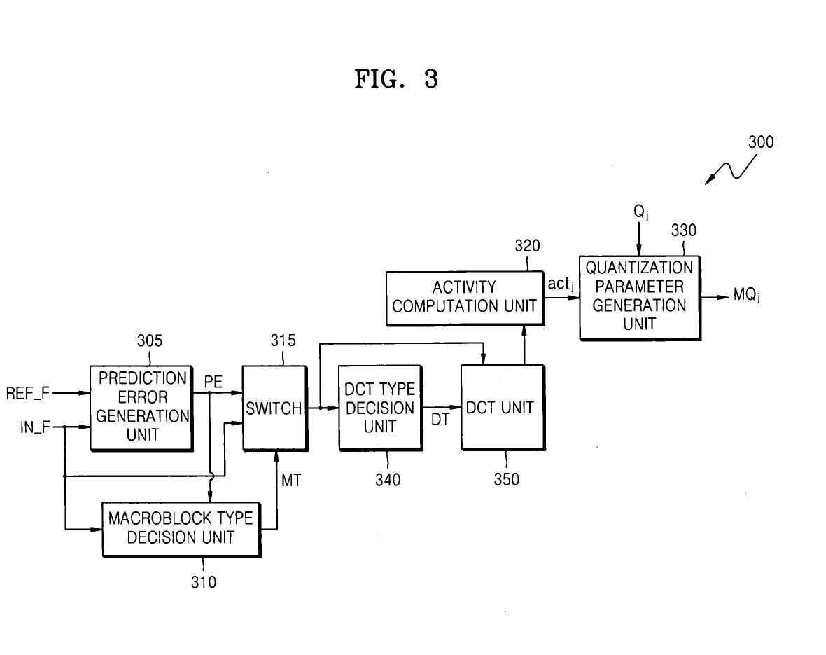

FIG. 3 is a block diagram illustrating an adaptive quantization controller 300 of a moving picture encoder according to another example embodiment of the present invention. In the example embodiment of FIG. 3, the adaptive quantization controller 300 may include a prediction error generation unit 305, a macroblock type decision unit 310, a switch 315, an activity computation unit 320, a quantization parameter generation unit 330, a DCT type decision unit 340, and a DCT unit 350. Further, in the example embodiment of FIG. 3, the structural configurations and operations of the prediction error generation unit 305, the macroblock type decision unit 310, the switch 315, and the quantization parameter generation unit 330 may be the same as those of the above-described prediction error generation unit 105, the macroblock type decision unit 110, the switch 115, and the quantization parameter generation unit 130 of FIG. 1, respectively, and thus will not be described further for the sake of brevity.

In the example embodiment of FIG. 3, the DCT type decision unit 340 may output DCT type information DT indicating whether to perform a DCT on either an inter macroblock of a prediction error PE or an intra macroblock of an input frame IN_F, received from the switch 315, into a frame structure or a field structure.

In the example embodiment of FIG. 3, the DCT unit 350 may perform a DCT corresponding to the DCT type information DT on the inter macroblock of the prediction error PE or the intra macroblock of the input frame IN_F in units of blocks with given pixel grid sizes (e.g., 8×8 pixels) and may output a resultant DCT coefficient.

In the example embodiment of FIG. 3, the DCT coefficient may be transferred to the activity computation unit 320. As discussed above, the activity computation unit 320 may include structural components similar to the activity computation unit 120 of the example embodiment of FIG. 1 (e.g., the prediction error/variance addition unit 122, the comparison unit 124, and the addition unit 126). The activity computation unit 320 may compute and output an activity value actⱼ (e.g., with Equations 1 and/or 2, wherein sblkₙ may indicate a frame structure sub-block or a field structure sub-block having a DCT type.) corresponding to the DCT coefficient.

In the example embodiment of FIG. 3, the adaptive quantization controller 300 may perform activity computation with a DCT coefficient of a DCT type, thereby reducing complexity during the activity computation.

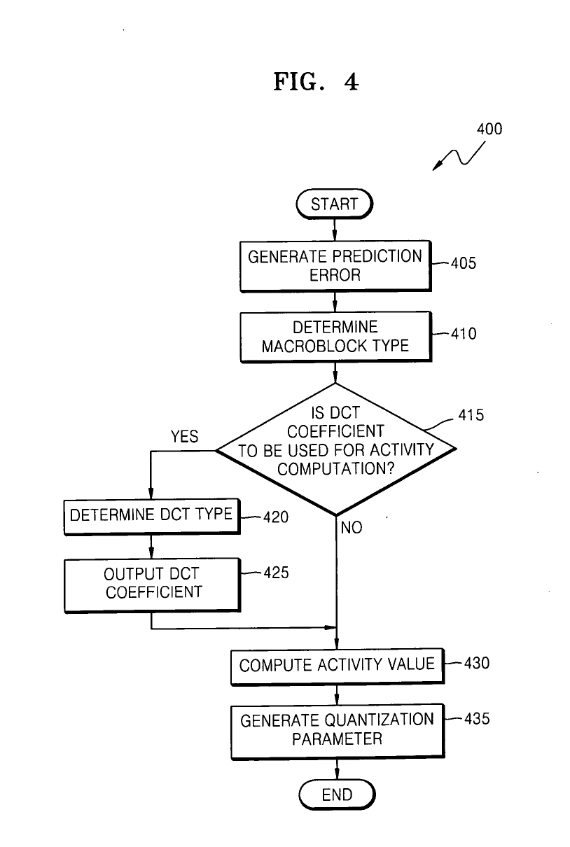

FIG. 4 is a flowchart illustrating an adaptive quantization control process 400 for a moving picture encoder according to another example embodiment of the present invention. In an example, the adaptive quantization control process 400 may be performed by the adaptive quantization controller 100 of FIG. 1 and/or the adaptive quantization controller 300 of FIG. 3.

In the example embodiment of FIG. 4, motion prediction (e.g., including motion estimation and/or motion compensation) may be performed on an input frame based on a reference frame. A prediction error may be generated (at 405) as a difference between the input frame and the reference frame.

In the example embodiment of FIG. 4, the input frame may be a current original frame and may include an I frame, a P frame, and a B frame based on an encoding mode of the moving picture encoder. In an example, a reference frame for the I frame may be an original frame of a preceding (e.g., previous) P frame or I frame. In an alternative example, the reference frame for the I frame may be a motion-compensated frame of the preceding P frame or I frame. In a further example, a reference frame for the P frame may be a motion-compensated frame of the preceding P frame or I frame, and a reference frame for the B frame may be a motion-compensated frame of the preceding P frame or I frame and a subsequent P frame or I frame. The motion prediction (at 405) may be based upon a reference block used in motion estimation of the I frame, the P frame, and the B frame. In an example, the reference block may be a 16×16 macroblock, a 4×4 macroblock, a 4×8 macroblock, an 8×4 macroblock, an 8×8 macroblock, an 8×16 macroblock, a 16×8 macroblock and/or any other sized macroblock.

In the example embodiment of FIG. 4, a macroblock type for the prediction error and/or the input frame may be determined (at 410). In an example, an inter macroblock may be determined as the macroblock type for the prediction error and an intra macroblock may be determined as the macroblock type for the input frame. In a further example, the prediction error and the input frame may be output as a frame.

In the example embodiment of FIG. 4, the result of DCT (e.g., a DCT coefficient) with respect to the inter macroblock of the prediction error and/or the intra macroblock of the input frame may be evaluated to determine whether the DCT coefficient may be used for activity computation (at 415). If the DCT coefficient is determined to be used in activity computation, the process advances to 420, which will be described later. Alternatively, if the DCT coefficient is not determined to be used in activity computation, the process of FIG. 4 advances to 430.

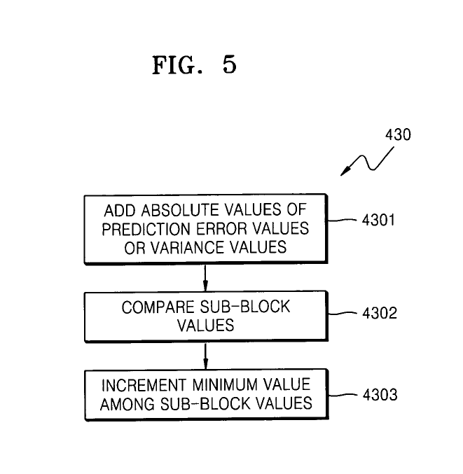

In the example embodiment of FIG. 4, a temporal and spatial activity value actⱼ of a macroblock j may be computed (at 430) based on the inter macroblock of the prediction error and/or the intra macroblock of the input frame, which will now be described in greater detail with respect to the example embodiment of FIG. 5.

FIG. 5 illustrates the activity value computation of 430 of FIG. 4 according to another example embodiment of the present invention. In the example embodiment of FIG. 5, at 4301, the activity computation 430 may include summing the absolute values of prediction error values Eₖⁿ included in the inter macroblock of the prediction error PE (e.g., in accordance with Equation 1) and outputting the summed result (e.g, as an 8×8 luminance sub-block value sblkₙ (n =1, 2, 3, or 4)). As discussed above with respect to Equation 1, Eₖⁿ may indicate a prediction error value in an nth 8×8 prediction video block. Alternatively, at 4301 of FIG. 5, the absolute values of variance values obtained by subtracting a mean sample value P_meanₙ from sample values (pixel values) Pₖⁿ included in the intra macroblock of the input frame IN_F may be summed and output (e.g., in accordance with Equation 2) (e.g., as an 8×8 luminance sub-block value sblkₙ (n =1, 2, 3, or 4)).

In the example embodiment of FIG. 5, at 4302, four sub-block values sblk₁, sblk₂, sblk₃, and sblk4 may be compared and the minimum value among the four sub-block values sblk₁, sblk₂, sblk₃, and sblk₄ may be output. The output minimum value may be incremented (e.g., by 1) and the activity value actⱼ may be output. In an example, 4302 and 4303 of FIG. 5 may be performed in accordance with Equation 3.

Returning to the example embodiment of FIG. 4, the determined macroblock (from 410) (e.g., the inter macroblock of the prediction error or the intra macroblock of the input frame) may be evaluated to determine whether to perform a DCT to convert the determined macroblock into a frame or field structure (at 420). Then, a DCT corresponding to the DCT type (determined at 420) may be performed on the determined macroblock in units of a given block size (e.g., 8×8 blocks) and a DCT coefficient may be output.

In the example embodiment of FIG. 4, the activity value actⱼ may be computed (e.g., based on Equation 1 or 2) corresponding to the DCT coefficient (at 430). At 430 of FIG. 4, sblkₙ (e.g., of either Equation 1 or Equation 2) may indicate a frame structure sub-block or a field structure sub-block according to the DCT type.

In the example embodiment of FIG. 4, a reference quantization parameter Qⱼ may be multiplied by a normalization value N_actⱼ of the activity value actⱼ to generate an adaptive quantization value (at 435) (e.g., quantization parameter MQⱼ ). The reference quantization parameter Qⱼ may be determined based on a degree to which an output buffer of the moving picture encoder is filled. In an example, the reference quantization parameter Qⱼ may be higher if the number of bits generated at the output buffer is greater than a reference value, and the reference quantization parameter Qⱼ may be lower if the number of bits generated from the output buffer is not greater than the reference value. The quantization parameter MQⱼ may be supplied to a quantizer (not shown) of the moving picture encoder. The quantizer may quantize a DCT coefficient output from a discrete cosine transformer of the moving picture encoder (not shown) in response to the quantization parameter MQⱼ , and may output a quantization coefficient. In an example, the quantization parameter generation of 435 of FIG. 4 may execute one or more of Equations 4 and 5.

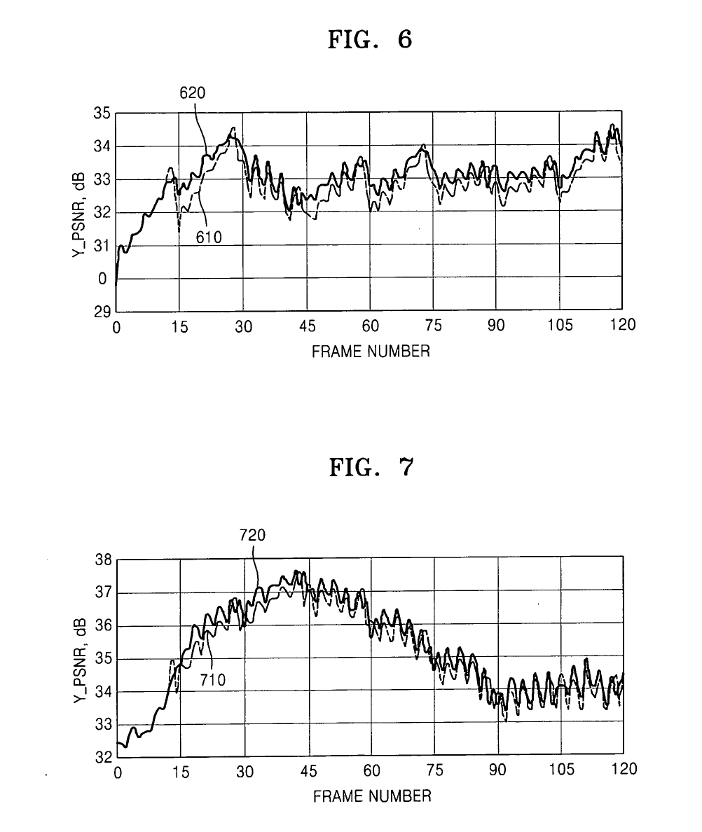

FIG. 6 is a graph illustrating a conventional peak signal-to-noise ratio (PSNR) curve 610 and a PSNR curve 620 according to an example embodiment of the present invention. In a further example, the PSNR curve 620 may be representative of an adaptive quantization control process applied to luminance blocks (Y) of a Paris video sequence. In an example, a bit-rate of the Paris video sequence may be 800 Kilobits per second (Kbps) and the Paris video sequence may include frames of a common intermediate format. However, it is understood that other example embodiments of the present invention may include other bit-rates and/or formats.

In the example embodiment of FIG. 6, the PSNR curve 620 may generally be higher than the PSNR curve 610, which may show that the example adaptive quantization controller and the example adaptive quantization control process may affect neighboring P/B frames of an I frame by an optimal rearrangement of a quantization value of the I frame, thereby providing an overall increase in subjective video quality.

FIG. 7 is a graph illustrating another conventional PSNR curve 710 and another PSNR curve according to an example embodiment of the present invention. In an example, the PSNR curve 720 may be representative of an adaptive quantization control process applied to luminance blocks (Y) of a Flag video sequence. In an example, a bit-rate of the Flag video sequence may be 800 Kilobits per second (Kbps) and the Flag video sequence may include frames of a common intermediate format. However, it is understood that other example embodiments of the present invention may include other bit-rates and/or formats.

In the example embodiment of FIG. 7, the PSNR curve 720 may generally be higher than the PSNR curve 710, which may show that the example adaptive quantization controller and the example adaptive quantization control process may affect neighboring P/B frames of an I frame by an optimal rearrangement of a quantization value of the I frame, thereby providing an overall increase in subjective video quality.

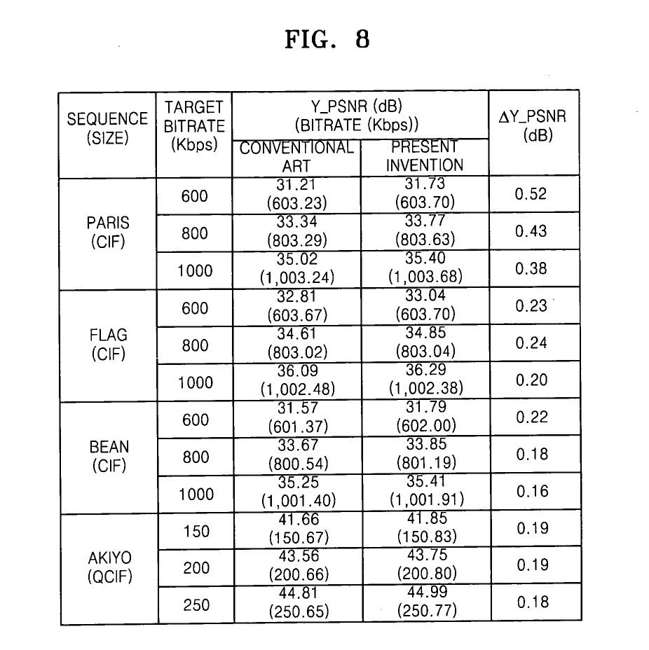

FIG. 8 illustrates a table showing set of simulation results of a conventional adaptive quantization control process and a set of simulation results for an adaptive quantization control process according to an example embodiment of the present invention. In the example simulation of FIG. 8, a number of frames included in a group of pictures may be 15 and each video sequence may include 300 frames.

In the example simulation of FIG. 8, a difference ΔY_PSNR between a PSNR according to an example embodiment of the present invention and a conventional PSNR in each video sequence may be greater than 0 dB. For example, at lower bit rates (e.g., such as 600 Kbps), ΔY_PSNR may reach a higher (e.g., maximum) value of 0.52 dB. The positive values of the ΔY_PSNR may reflect an improve image quality responsive to the adaptive quantization controller and the adaptive quantization control process according to example embodiments of the present invention.

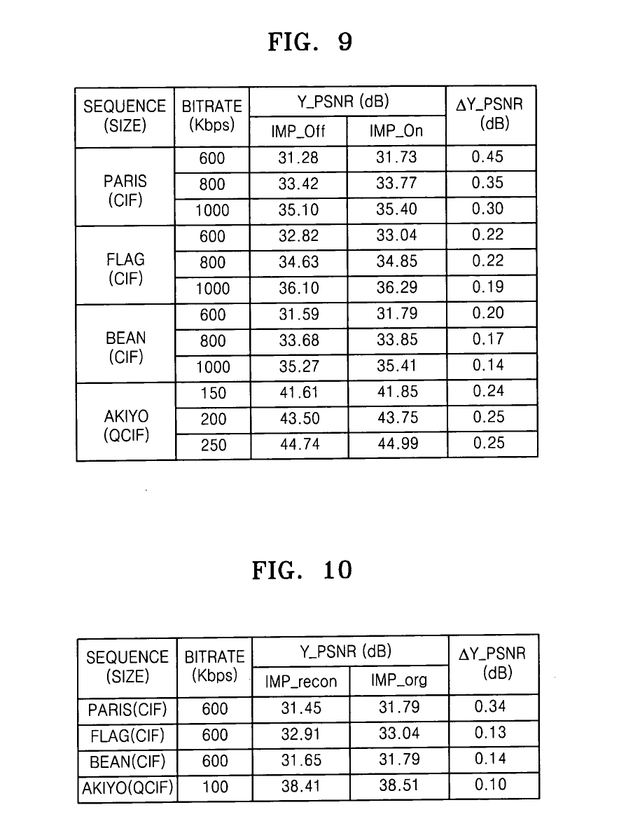

FIG. 9 illustrates a table showing a set of simulation results of motion prediction using an I frame motion prediction and a set of simulation results of motion prediction without using I frame motion prediction according to example embodiments of the present invention. In the example simulation of FIG. 9, a number of frames included in a group of pictures may be 15 and each video sequence may include 300 frames.

In the example simulation of FIG. 9, in each video sequence, a difference ΔY_PSNR between a PSNR when I frame motion prediction is used (IMP_On) and a PSNR when I frame motion prediction is not used (IMP_Off) may be greater than 0 dB. The positive values of the ΔY_PSNR may reflect an improve image quality responsive to the I frame motion prediction used in example embodiments of the present invention.

FIG. 10 illustrates a table showing a set of simulation results for motion prediction wherein a reference frame of an I frame is an original frame and a set of simulation results wherein the reference frame of the I frame is a motion-compensated frame according to example embodiments of the present invention. In the example simulation of FIG. 10, a number of frames included in a group of pictures may be 15 and each video sequence may include 300 frames.

In the example simulation of FIG. 10, in each video sequence, a difference ΔY_PSNR between a PSNR when a reference frame of an I frame is the original frame (IMP_org) and a PSNR when the reference frame of an I frame is a motion-compensated frame (IMP_recon) may be greater than 0 dB. The positive values of the ΔY_PSNR may reflect an improve image quality responsive to using an original frame as the reference frame for the I frame in example embodiments of the present invention.

Example embodiments of the present invention being thus described, it will be obvious that the same may be varied in many ways. For example, while above-described elements are discussed as being configured for certain formats and sizes (e.g., macroblocks at 16×16 pixels, etc.), it is understood that the numerical examples given above may scale in other example embodiments of the present invention to conform with well-known video protocols.

Such variations are not to be regarded as a departure from the spirit and scope of example embodiments of the present invention, and all such modifications as would be obvious to one skilled in the art are intended to be included within the scope of the following claims.

What is claimed is:

1. An adaptive quantization controller, comprising:
a prediction error generation unit performing motion prediction on at least one frame included within an input frame based on a reference frame and generating a prediction error, the prediction error being a difference value between the input frame and the reference frame;
an activity computation unit outputting an activity value based on a received macroblock, the received macroblock associated with one of the input frame and the prediction error; and
a quantization parameter generation unit generating a quantization parameter by multiplying a reference quantization parameter by a normalization value of the outputted activity value.

2. The adaptive quantization controller of claim 1, wherein the at least one frame includes one or more of an I frame, a P frame, and a B frame.

3. The adaptive quantization controller of claim 1, wherein the received macroblock is one of an intra macroblock and an inter macroblock.

4. The adaptive quantization controller of claim 1, wherein the quantization parameter generation unit generates the reference quantization parameter based on a degree to which an output buffer included is filled.

5. The adaptive quantization controller of claim 2, wherein a reference frame for the I frame is an original frame of a preceding P frame or I frame.

6. The adaptive quantization controller of claim 2, wherein a reference frame for the I frame is a motion-compensated frame of a preceding P frame or I frame.

7. The adaptive quantization controller of claim 1, wherein the prediction error generation unit performs motion prediction including motion estimation and motion compensation.

8. The adaptive quantization controller of claim 7, wherein a reference block used during the motion prediction for the at least one frame is a macroblock of a given size.

9. The adaptive quantization controller of claim 8, wherein, in terms of pixels, the given size is 16×16, 4×4, 4×8, 8×4, 8×8, 8×16 or 16×8.

10. The adaptive quantization controller of claim 1, further comprising:
a macroblock type decision unit outputting macroblock type information, the macroblock type information indicating whether the received macroblock is an inter macroblock or an intra macroblock in response to the prediction error and the input frame; and
a switch outputting one of the prediction error and the input frame to the activity computation unit in response to the macroblock type information.

11. The adaptive quantization controller of claim 1, wherein the activity computation unit includes:
a prediction error/variance addition unit summing absolute values of prediction error values included in the received macroblock if the received macroblock is an inter macroblock of the prediction error and summing the absolute values of variance values obtained by subtracting a mean sample value from sample values included in the received macroblock if the received macroblock is an intra macroblock of the input frame and outputting the summed result as one of a plurality of sub-block values;
a comparison unit comparing the plurality of sub-block values and outputting a minimum value of the plurality of sub-block values; and
an addition unit incrementing the outputted minimum value and outputting the activity value of the received macroblock.

12. The adaptive quantization controller of claim 1, further comprising:
a discrete cosine transform (DCT) unit performing DCT corresponding to DCT type information of the received macroblock and outputting a DCT coefficient,
wherein the activity computation unit receives the DCT coefficient and determines the outputted activity value of the received macroblock based on the DCT coefficient.

13. The adaptive quantization controller of claim 12, wherein the quantization parameter generation unit generates the reference quantization parameter based on a degree to which an output buffer included is filled, and the DCT type information indicates whether to perform a DCT on the received macroblock.

14. The adaptive quantization controller of claim 12, further comprising:
a macroblock type decision unit outputting macroblock type information indicating whether the received macroblock is an inter macroblock or an intra macroblock in response to the prediction error and the input frame;
a switch outputting the received macroblock to the activity computation unit in response to the macroblock type information; and
a DCT type decision unit outputting the DCT type information to the DCT unit in response to the received macroblock outputted from the switch.

15. A method of adaptive quantization control, comprising:
performing motion prediction on at least one frame included in an input frame based on a reference frame;
generating a prediction error, the prediction error being a difference value between the input frame and the reference frame;
computing an activity value based on a received macroblock, the received macroblock associated with one of the input frame and the prediction error; and
generating a quantization parameter by multiplying a reference quantization parameter by a normalization value of the computed activity value.

16. The method of claim 15, wherein computing the activity value is based at least in part on a discrete cosine transform (DCT) coefficient corresponding to a DCT type of the received macroblock.

17. The method of claim 15, wherein the quantization parameter generation unit generates the reference quantization parameter based on a degree to which an output buffer included is filled, and the DCT type information indicates whether to perform a DCT on the received macroblock.

18. The method of claim 15, wherein the at least one frame includes one or more of an I frame, a P frame, and a B frame.

19. The method of claim 18, wherein a reference frame for the I frame is an original frame of a preceding P frame or I frame.

20. The method of claim 18, wherein a reference frame for the I frame is a motion-compensated frame of a preceding P frame or I frame.

21. The method of claim 15, wherein the motion prediction includes motion estimation and motion compensation.

22. The method of claim 21, wherein a reference block used in the motion estimation of the at least one frame is a macroblock of a given size.

23. The method of claim 22, wherein, in terms of pixels, the given size is 16×16, 4×4, 4×8, 8×4, 8×8, 8×16 or 16×8.

24. The method of claim 16, further comprising:
first determining whether the received macroblock is an inter macroblock of the prediction error or an inter macroblock of the input frame;
second determining whether to compute the activity value of the received macroblock based on the DCT coefficient;
third determining whether to perform a DCT on the received macroblock;
performing a DCT on the received macroblock based at least in part on whether the received macroblock is an intermacroblock or an intra macroblock and outputting the DCT coefficient,
wherein the quantization parameter is generated if the second determining step determines not to compute the activity value based on the DCT coefficient and the quantization parameter is generated only after the third determining and performing steps if the second determining step determines to compute the activity value based on the DCT coefficient.

25. The method of claim 15, generating the quantization parameter includes:
summing absolute values of prediction error values included in the received macroblock if the received macroblock is an inter macroblock of the prediction error and summing the absolute values of variance values obtained by subtracting a mean sample value from sample values included in the received macroblock if the received macroblock is an intra macroblock of the input frame and outputting the summed result as one of a plurality of sub-block values;
comparing the plurality of sub-block values and outputting a minimum value of the plurality of sub-block values; and
incrementing the outputted minimum value and outputting the activity value of the received macroblock.

26. A method of adaptive quantization control, comprising:
receiving an input frame including an I frame; and
performing motion prediction for the I frame based at least in part on information extracted from one or more previous input frames.

27. An adaptive quantization controller performing the method of claim 15.

28. An adaptive quantization controller performing the method of claim 26.
